(19) United States
(12) Patent Application Publication
(10) Pub. No.: US 2026/0138314 A1
(43) Pub. Date: May 21, 2026

(54) THERMOPLASTIC RESIN COMPOSITION AND MOLDED ARTICLE

(71) Applicant: TECHNO-UMG CO., LTD., Tokyo (JP)

(72) Inventors: Shinji FUJII, Tokyo (JP); Hisashi KUSAKA, Tokyo (JP)

(21) Appl. No.: 19/446,868

(22) Filed: Jan. 12, 2026

Related U.S. Application Data
(63) Continuation of application No. PCT/JP2025/022253, filed on Jun. 20, 2025.

(30) Foreign Application Priority Data
Jul. 4, 2024 (JP) 2024-108366

(51) Int. Cl. B29C 45/00; B29K 21/00; B29K 25/00; B29K 55/00; B29K 69/00; C08F 220/48; C08F 279/04; C08G 64/06; C08K 5/103; C08L 69/00

(52) U.S. Cl. CPC B29C 45/0001; C08F 220/48; C08F 279/04; C08G 64/06; C08K 5/103; C08L 69/00; B29K 2021/003; B29K 2025/00; B29K 2055/00; B29K 2069/00; C08L 2205/035; C08L 2207/04

(57) ABSTRACT

A thermoplastic resin composition resin composition contains: 1 to 50 parts by mass of a specific polycarbonate resin (A) containing an isosorbide structure; 10 to 45 parts by mass of a graft copolymer (B) obtained by graft polymerizing a rubbery polymer (a) with a monomer (b) containing an aromatic vinyl-based monomer and a vinyl cyanide-based monomer; 5 to 49 parts by mass of an aromatic vinyl-vinyl cyanide-based copolymer (C) obtained by copolymerizing a monomer (c) containing an aromatic vinyl-based monomer and a vinyl cyanide-based monomer; and 0 to 40 parts by mass of an aromatic polycarbonate resin (D). (A total of the polycarbonate resin (A), the graft copolymer (B), the aromatic vinyl-vinyl cyanide-based copolymer (C), and the aromatic polycarbonate resin (D) is 100 parts by mass.) A molded article obtained by molding this thermoplastic resin composition.

### CROSS-REFERENCE TO RELATED APPLICATIONS

The present application is a continuation of International Patent Application PCT/JP2025/022253, filed Jun. 20, 2025, which is based on and claims the benefit of priority to Japanese Patent Application No. 2024-108366 filed on Jul. 4, 2024. The entire contents of these applications are incorporated herein by reference.

### TECHNICAL FIELD

The present invention relates to a thermoplastic resin composition having excellent weather resistance, moist heat aging resistance, impact resistance, and heat resistance. The present invention also relates to a molded article obtained by molding the thermoplastic resin composition.

### BACKGROUND ART

In recent years, in order to realize a sustainable society, it has been strongly demanded to eliminate or reduce the emission of carbon dioxide as an environmental load, which has become a global challenge.

In particular, efforts have been made to expand the use of plant-derived materials in resin parts for automobiles and electrical appliances, rather than petroleum-derived plastics.

Plant-derived materials designed to reduce environmental impact have already been put to practical use, and examples of materials that have been developed include polylactic acid resin, polyamide 11 resin made from plant-derived monomers, and polycarbonate resin that contains plant-derived isosorbide structures.

When these plant-derived materials have low impact strength, they are often used by compensating for this in design aspects such as article shape, and the like. Development is also underway to increase the strength of the materials themselves.

In particular, materials for various industrial applications, especially for automotive resin parts, are required to exhibit excellent impact resistance, weather resistance to minimize discoloration even when exposed to direct sunlight, and heat resistance to minimize deformation even when exposed to high temperatures due to direct sunlight. Furthermore, materials with minimal change in properties over the long term are required from the perspective of product safety.

There is also a demand for the use of recycled raw materials and for the recyclability of the resins themselves used in products.

As described above, industrial resins are required to have many properties, but it is difficult to satisfy all of them.

Against this background, Patent Literature 1 discloses a thermoplastic resin composition comprising a polycarbonate resin containing an isosorbide structure blended with an AES graft copolymer, and further comprising an aromatic polycarbonate resin.

However, when the amount of the polycarbonate resin containing an isosorbide structure used in this thermoplastic resin composition was increased to around 50%, it was difficult to achieve sufficient moist heat aging resistance while maintaining impact strength, heat resistance, and weather resistance. This has resulted in a problem that the applications of the composition are limited due to the lack of moist heat aging resistance.

### CITATION LIST

### Patent Literature

[Patent Literature 1] JP 2016-44221 A

### SUMMARY OF INVENTION

### Technical Problem

An object of the present invention is to provide a thermoplastic resin composition that exhibits excellent weather resistance, moist heat aging resistance, impact resistance, and heat resistance, and a molded article obtained by molding this thermoplastic resin composition. A further object of the present invention is to provide a thermoplastic resin composition that also exhibits excellent recyclability and a molded article thereof.

### Solution to Problem

The inventors of the present invention have discovered that the above-mentioned problem can be solved by blending in specified proportions a polycarbonate resin (A) containing an isosorbide structure, a graft copolymer (B) obtained by graft polymerizing a rubbery polymer (a) with a monomer (b) containing an aromatic vinyl-based monomer and a vinyl cyanide-based monomer, an aromatic vinyl-vinyl cyanide-based copolymer (C) obtained by copolymerizing a monomer containing an aromatic vinyl-based monomer and a vinyl cyanide-based monomer, and an aromatic polycarbonate resin (D).

The present invention is summarized as follows.

[1] A thermoplastic resin composition comprising:
1 to 50 parts by mass of a polycarbonate resin (A) containing an isosorbide structure, the polycarbonate resin (A) containing 65 to 75% by mol of structural units derived from dihydroxy compounds represented by the following formula (1) among all structural units derived from dihydroxy compounds constituting the polycarbonate resin (A), and further containing 0.01 to 0.1% by mass of a benzotriazole-based compound;
10 to 45 parts by mass of a graft copolymer (B) obtained by graft polymerizing a rubbery polymer (a) with a monomer (b) containing an aromatic vinyl-based monomer and a vinyl cyanide-based monomer;
5 to 49 parts by mass of an aromatic vinyl-vinyl cyanide-based copolymer (C) obtained by copolymerizing a monomer (c) containing an aromatic vinyl-based monomer and a vinyl cyanide-based monomer; and
0 to 40 parts by mass of an aromatic polycarbonate resin (D),
wherein a total of the polycarbonate resin (A), the graft copolymer (B), the aromatic vinyl-cyanide vinyl-based copolymer (C), and the aromatic polycarbonate resin (D) is 100 parts by mass.

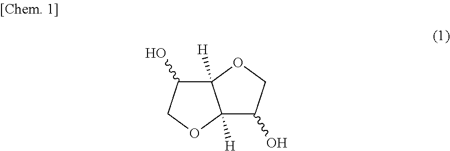

[2] The thermoplastic resin composition according to [1], wherein the aromatic vinyl-vinyl cyanide-based copolymer (C) has a mass-average molecular weight (Mw) of 50,000 to 350,000 and a ratio of the mass-average molecular weight (Mw) to a number-average molecular weight (Mn) (Mw/Mn) of 1.5 to 3.5.
[3] A molded article obtained by molding the thermoplastic resin composition according to [1] or [2].

### Advantageous Effects of Invention

According to the present invention, a thermoplastic resin composition that exhibits excellent weather resistance, moist heat aging resistance, impact resistance, and heat resistance, and a molded article thereof are provided.

According to the present invention, it is possible to achieve impact strength, heat resistance, weather resistance, and moist heat aging resistance even when a content of a polycarbonate resin containing an isosorbide structure is increased up to 50%.

Furthermore, the thermoplastic resin composition of the present invention has excellent recyclability, leading to an efficient use of resources.

### DESCRIPTION OF EMBODIMENTS

The present invention is described in detail below.

### [Thermoplastic Resin Composition]

The thermoplastic resin composition of the present invention (hereinafter sometimes simply referred to as “resin composition”) comprises, as resin components:
1 to 50 parts by mass of a polycarbonate resin (A) containing an isosorbide structure, the polycarbonate resin (A) (hereinafter sometimes referred to as “isosorbide-based polycarbonate resin (A) of the present invention”, “isosorbide-based polycarbonate resin (A)”, or “component (A)”) containing 65 to 75% by mol of structural units derived from dihydroxy compounds represented by the following formula (1) among all structural units derived from dihydroxy compounds constituting the polycarbonate resin (A), and further containing 0.01 to 0.1% by mass of a benzotriazole-based compound;
10 to 45 parts by mass of a graft copolymer (B) (hereinafter sometimes referred to as “component (B)”) obtained by graft polymerizing a rubbery polymer (a) with a monomer (b) containing an aromatic vinyl-based monomer and a vinyl cyanide-based monomer;
5 to 49 parts by mass of an aromatic vinyl-vinyl cyanide-based copolymer (C) (hereinafter sometimes referred to as “component (C)”) obtained by copolymerizing a monomer (c) containing an aromatic vinyl-based monomer and a vinyl cyanide-based monomer; and
0 to 40 parts by mass of an aromatic polycarbonate resin (D) (hereinafter sometimes referred to as “component (D)”),
wherein a total of the components (A) to (D) is 100 parts by mass.

In the thermoplastic resin composition of the present invention, the resin components refers to the total of the isosorbide-based polycarbonate resin (A), the graft copolymer (B), the aromatic vinyl-vinyl cyanide-based copolymer (C), and the aromatic polycarbonate resin (D). Furthermore, when the thermoplastic resin composition of the present invention contains a resin other than those listed above, the term “resin components” refers to the total of all resins including such other resin.

### [Polycarbonate Resin (A) Containing an Isosorbide Structure]

The isosorbide-based polycarbonate resin (A) used in the present invention is a polycarbonate resin containing 65 to 75% by mol of structural units derived from dihydroxy compounds represented by the following formula (1) among all structural units derived from dihydroxy compounds constituting the polycarbonate resin (A). The isosorbide-based polycarbonate resin (A) is preferably a polycarbonate resin containing structural units derived from the dihydroxy compounds represented by the following formula (1) and structural units derived from cyclohexanedimethanol.

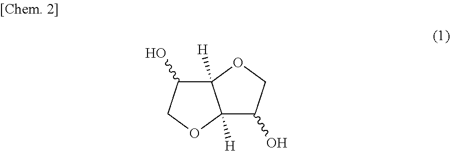

Examples of the dihydroxy compound represented by the above formula (1) include isosorbide, isomannide, and isoidet, which are stereoisomers of one another. These may be used alone or in combination of two or more.

Among these, isosorbide is most preferred in terms of availability and ease of production, moldability, heat resistance, impact resistance, surface hardness, and carbon neutrality. Isosorbide may be obtained by dehydration condensation of sorbitol, which is produced from various starches that are abundant and easily available as plant-derived resources.

Examples of cyclohexanedimethanol include 1,2-cyclohexanedimethanol, 1,3-cyclohexanedimethanol. and 1,4-cyclohexanedimethanol. Among these, 1,4-cyclohexanedimethanol is preferred due to its ease of availability.

The isosorbide-based polycarbonate resin (A) used in the present invention may contain structural units derived from one or more dihydroxy compounds (hereinafter sometimes referred to as “other dihydroxy compounds”) other than the dihydroxy compound represented by the above formula (1) and cyclohexanedimethanol.

Examples of the other dihydroxy compounds include aliphatic dihydroxy compounds such as ethylene glycol, 1,3-propanediol, 1,2-propanediol, 1,4-butanediol, 1,3-butanediol, 1,2-butanediol, 1,5-heptanediol, 1,6-hexanediol, and the like; alicyclic dihydroxy compounds such as tricyclodecanedimethanol, pentacyclopentadecanedimethanol, 2,6-decalindimethanol, 1,5-decalindimethanol, 2,3-decalindimethanol, 2,3-norbornanedimethanol, 2,5-norbornanedimethanol, 1,3-adamantanedimethanol, and the like; aromatic bisphenols such as 2,2-bis(4-hydroxyphenyl)propane [=bisphenol A], 2,2-bis(4-hydroxy-3,5-dimethylphenyl)propane, 2,2-bis(4-hydroxy-3,5-diethylphenyl)propane, 2,2-bis(4-hydroxy-(3,5-diphenyl)phenyl)propane, 2,2-bis(4-hydroxy-3,5-dibromophenyl)propane, 2,2-bis(4-hydroxyphenyl)pentane, 2,4′-dihydroxy-diphenylmethane, bis(4-hydroxyphenyl)methane, bis(4-hydroxy-5-nitrophenyl)methane, 1,1-bis(4-hydroxyphenyl)ethane, 3,3-bis(4-hydroxyphenyl)pentane, 1,1-bis(4-hydroxyphenyl)cyclohexane, bis(4-hydroxyphenyl)sulfone, 2,4′-dihydroxydiphenylsulfone, bis(4-hydroxyphenyl)sulfide, 4,4′-dihydroxydiphenylether, 4,4′-dihydroxy-3,3′-dichlorodiphenylether, 9,9-bis(4-(2-hydroxyethoxy-2-methyl)phenyl)fluorene, 9,9-bis(4-hydroxyphenyl)fluorene, 9,9-bis(4-hydroxy-2-methylphenyl)fluorene, and the like.

When the isosorbide-based polycarbonate resin (A) contains the structural units derived from the dihydroxy compound represented by the formula (1) and the structural units derived from cyclohexanedimethanol, it is preferable that the proportion of the structural units derived from cyclohexanedimethanol among all structural units derived from dihydroxy compounds contained in the isosorbide-based polycarbonate resin (A) is 35% by mol or less, for example, 25 to 35% by mol, and particularly 27 to 32% by mol. When the isosorbide-based polycarbonate resin (A) contains the structural units derived from cyclohexanedimethanol, it is less likely to undergo coloration and the effects of increasing molecular weight, improving impact strength, and improving glass transition temperature are achieved. When the proportion of structural units derived from cyclohexanedimethanol is too high, the effects of including structural units derived from the dihydroxy compound represented by the formula (1) are impaired, which is undesirable.

From the viewpoints of reducing coloration, increasing molecular weight, improving impact strength, and increasing glass transition temperature, the content of the structural units derived from the dihydroxy compound represented by the above formula (1) in the isosorbide-based polycarbonate resin (A) is 65 to 75% by mol, and preferably 68 to 73% by mol, based on the total structural units derived from dihydroxy compounds contained in the isosorbide-based polycarbonate resin (A).

Furthermore, when the isosorbide-based polycarbonate resin (A) contains structural units derived from the other dihydroxy compounds, the content of the structural units derived from the other dihydroxy compounds is preferably 10% by mol or less, and more preferably 5% by mol or less, based on the total structural units derived from dihydroxy compounds contained in the isosorbide-based polycarbonate resin (A). When the isosorbide-based polycarbonate resin (A) contains the structural units derived from the other dihydroxy compounds, impact resistance and molded appearance are improved, but an excessively high proportion of these structural units reduces heat resistance. Furthermore, when the isosorbide-based polycarbonate resin (A) contains structural units derived from aromatic bisphenols as structural units derived from the other dihydroxy compounds, heat resistance is improved, but when this proportion is excessively high, impact strength deteriorates.

The isosorbide-based polycarbonate resin (A) of the present invention contains 0.01 to 0.1% by mass of a benzotriazole-based compound. By including the benzotriazole-based compound in the isosorbide-based polycarbonate resin (A), the resin has excellent weather resistance even when mixed with other resins.

Specific examples of the benzotriazole-based compound include 2-(2′-hydroxy-3′-methyl-5′-hexylphenyl)benzotriazole, 2-(2′-hydroxy-3′-t-butyl-5′-hexylphenyl)benzotriazole, 2-(2′-hydroxy-3′,5′-di-t-butylphenyl)benzotriazole, 2-(2′-hydroxy-3′-methyl-5′-t-octylphenyl)benzotriazole, 2-(2′-hydroxy-5′-t-dodecylphenyl)benzotriazole, 2-(2′-hydroxy-5′-t-octylphenyl)benzotriazole, 2-(2′-hydroxy-3′-methyl-5′-t-dodecylphenyl)benzotriazole, 2-(2′-hydroxy-5′-t-butylphenyl)benzotriazole, methyl-3-(3-(2H-benzotriazol-2-yl)-5-t-butyl-4-hydroxyphenyl) propionate, and the like.

The isosorbide-based polycarbonate resin (A) of the present invention may contain one of these benzotriazole-based compounds, or two or more thereof.

Examples of commercially available products of such benzotriazole-based compounds include Adekastab (registered trademark) LA-29 manufactured by ADEKA Corporation, and the like.

The content of the benzotriazole-based compound in the isosorbide-based polycarbonate resin (A) of the present invention is preferably 0.02 to 0.08% by mass, and more preferably 0.02 to 0.05% by mass, from the viewpoint of achieving excellent weather resistance even when mixed with other resins.

The isosorbide-based polycarbonate resin (A) of the present invention contains the benzotriazole-based compound in the content ratio described above, and preferably contains the following polyhydric alcohol fatty acid ester in the following preferred ratios. Therefore, the isosorbide-based polycarbonate resin (A) of the present invention is also referred to as a “polycarbonate resin composition.” However, it will be referred to as a “polycarbonate resin” in the present invention, because the content of these benzotriazole-based compounds and polyhydric alcohol fatty acid esters in the isosorbide-based polycarbonate resin (A) is very small.

The isosorbide-based polycarbonate resin (A) of the present invention preferably contains a polyhydric alcohol fatty acid ester from the viewpoint of imparting mold releasability during molding.

In the polyhydric alcohol fatty acid ester, the fatty acid is preferably a higher fatty acid, and more preferably a saturated fatty acid having 10 to 30 carbon atoms. Examples of such fatty acids include myristic acid, lauric acid, palmitic acid, stearic acid, behenic acid, and the like.

In the polyhydric alcohol fatty acid ester, the polyhydric alcohol is preferably ethylene glycol. In this case, when added to the resin, mold releasability can be improved without impairing the transparency of the resin.

The polyhydric alcohol fatty acid ester is preferably a partial ester or full ester of a polyhydric alcohol having 1 to 20 carbon atoms and a saturated fatty acid having 10 to 30 carbon atoms. Examples of such partial esters or full esters of polyhydric alcohols and saturated fatty acids include stearic acid monoglyceride, stearic acid diglyceride, stearic acid triglyceride, stearic acid monosorbitate, behenic acid monoglyceride, pentaerythritol monostearate, pentaerythritol distearate, pentaerythritol tetrastearate, pentaerythritol tetrapelargonate, propylene glycol monostearate, isopropyl palmitate, sorbitan monostearate, and the like. Among these, stearic acid monoglyceride, stearic acid triglyceride, and pentaerythritol tetrastearate are preferably used.

From the viewpoints of heat resistance and moisture resistance, full esters are more preferred as the polyhydric alcohol fatty acid esters.

The isosorbide-based polycarbonate resin (A) of the present invention may contain one of these polyhydric alcohol fatty acid esters, or two or more thereof.

Examples of commercially available products of such polyhydric alcohol fatty acid esters include ethylene glycol distearate E-275 manufactured by NOF Corporation.

From the viewpoint of achieving excellent mold releasability during molding, the content of the polyhydric alcohol fatty acid ester in the isosorbide-based polycarbonate resin (A) of the present invention is preferably 0.1 to 0.5% by mass, and more preferably 0.2 to 0.4% by mass.

The isosorbide-based polycarbonate resin (A) used in the present invention can be produced by a commonly used production method.

The production method for the isosorbide-based polycarbonate resin (A) may be either a solution polymerization method using phosgene or a melt polymerization method involving reaction with a carbonate diester. As a method for producing the isosorbide-based polycarbonate resin (A), a melt polymerization method is preferred in which a dihydroxy compound containing the dihydroxy compound represented by the above formula (1) is reacted with a carbonate diester, which is less toxic to the environment, in the presence of a polymerization catalyst.

In such a common production method, the isosorbide-based polycarbonate resin (A) suitable for the present invention can be obtained by adding the aforementioned benzotriazole-based compound and further a polyhydric alcohol fatty acid ester to the reaction system and carrying out the reaction in the presence of these additives, or by adding the aforementioned benzotriazole-based compound and further a polyhydric alcohol fatty acid ester to the polycarbonate resin obtained after the reaction.

Examples of the carbonate diester used in the melt polymerization method include those represented by the following general formula (2). These carbonate diesters may be used alone or in combination of two or more.

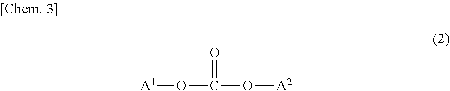

(In the general formula (2), A¹ and A² represent an optionally substituted aliphatic group having 1 to 18 carbon atoms or an optionally substituted aromatic group, and A¹ and A² may be the same or different.)

Examples of the carbonate diesters represented by the above general formula (2) include diphenyl carbonate, substituted diphenyl carbonates such as ditolyl carbonate and the like, dimethyl carbonate, diethyl carbonate, di-t-butyl carbonate, and the like.

Among these, diphenyl carbonate and substituted diphenyl carbonates are preferred, and diphenyl carbonate is particularly preferred.

Known alkali metal compounds and/or alkaline earth metal compounds are used as polymerization catalysts (ester interchange catalysts) in the melt polymerization. It is also possible to use, as auxiliary agents, basic compounds such as basic boron compounds, basic phosphorus compounds, basic ammonium compounds, amine-based compounds, and the like, in combination with the alkali metal compounds and/or alkaline earth metal compounds.

The polymerization reaction may be carried out using a known type of process and can be conducted in a batch process, a continuous process, or a combination of batch and continuous processes.

In the present invention, the mass-average molecular weight (Mw) of the isosorbide-based polycarbonate resin (A) is preferably 25,000 to 60,000, more preferably 30,000 to 60,000, and particularly preferably 35,000 to 58,000, from the viewpoints of the appearance and impact resistance of the resulting molded article.

When the mass-average molecular weight of the isosorbide-based polycarbonate resin (A) is more than this range, the fluidity will decrease. When the mass-average molecular weight of the isosorbide-based polycarbonate resin (A) is less than this range, the impact resistance and heat resistance of the resulting molded article will decrease, resulting in a poor appearance.

Here, the MFR of the isosorbide-based polycarbonate resin (A) can be used as a measure of the mass-average molecular weight. The MFR of the isosorbide-based polycarbonate resin (A) measured under the conditions of ISO 1133 (230° C./2.16 kg) is preferably in the range of 2 to 30 g/10 min, more preferably 3 to 20 g/10 min, and even more preferably 4 to 15 g/10 min. When the MFR of the isosorbide-based polycarbonate resin (A) is within this range, the excellent properties of the thermoplastic resin composition of the present invention, such as fluidity, impact resistance, heat resistance, and appearance can be more effectively exhibited.

Examples of commercially available products of such isosorbide-based polycarbonate resin (A) include D7340R, D6350R, D5360R, and D5380R-3 under the DURABIO (registered trademark) brand manufactured by Mitsubishi Chemical Corporation.

One type of the isosorbide-based polycarbonate resin (A) may be used alone, or two or more types with different constituent types, compositions, physical properties, and the like may be mixed and used.

The blending amount of the isosorbide-based polycarbonate resin (A) in the resin composition of the present invention is 1 to 50 parts by mass, preferably 11 to 50 parts by mass, more preferably 21 to 50 parts by mass, and most preferably 26 to 50 parts by mass based on 100 parts by mass of the total of the components (A) to (D), because the resulting resin composition and molded articles thereof are excellent in the molded appearance, impact resistance, and heat resistance.

In order to achieve better performance, the blending amount of the isosorbide-based polycarbonate resin (A) may be 36 to 50 parts by mass or even 40 to 50 parts by mass based on 100 parts by mass of the total of the components (A) to (D).

When the blending amount of the isosorbide-based polycarbonate resin (A) is more than this range, the impact resistance and heat resistance decrease. When the blending amount of the isosorbide-based polycarbonate resin (A) is less than this range, the appearance deteriorates.

### [Graft Copolymer (B)]

The graft copolymer (B) contained in the thermoplastic resin composition of the present invention is obtained by graft polymerizing a monomer (b) containing an aromatic vinyl-based monomer and a vinyl cyanide-based monomer onto a rubbery polymer (a).

Examples of the rubbery polymer (a) that forms the graft copolymer (B) include diene-based rubbers such as polybutadiene, styrene-butadiene copolymer, acrylonitrile-butadiene copolymer, acrylic ester-butadiene copolymer, styrene-isoprene copolymer, natural rubber, and the like; acrylic rubbers such as polybutyl acrylate, and the like; olefin-based rubbers such as ethylene-propylene copolymer, ethylene-propylene-nonconjugated diene copolymer, ethylene-α-olefin copolymer, and the like; and silicone-based rubbers such as polyorganosiloxane, and the like. These may be used alone or as a mixture of two or more types. The structure of the rubbery polymer (a) may also be of a composite type, for example, polybutadiene polymerized with an acrylic ester or polyorganosiloxane polymerized with an acrylic ester. Among these rubbery polymers (a), acrylic rubber, silicone-based rubber, and olefin-based rubber are preferred because they provide excellent weather resistance to the resulting resin composition.

The volume average particle diameter of the rubbery polymer (a) is preferably 90 to 460 nm, more preferably 100 to 440 nm, and even more preferably 120 to 390 nm. When the volume average particle diameter of the rubbery polymer (a) is within the above range, the resulting resin composition and molded article exhibit excellent impact resistance and molded appearance.

The volume average particle diameter of the rubbery polymer (a) is measured using the method described in the Examples section below.

There are no particular limitations on the method for controlling the particle size of the rubbery polymer (a), and any known method can be used. In particular, methods such as adjusting the type or amount of an emulsifier used when producing an emulsified latex of the rubber polymer (a), the shear force applied during kneading, temperature conditions, moisture content, and the like are preferred because they allow for easy control of the particle size. Increasing the amount of the emulsifier used, increasing the shear force applied during kneading, raising the temperature, or increasing the moisture content tends to reduce the particle size of the rubber polymer (a).

There are no particular limitations on the method for producing an emulsified latex of the rubber polymer (a), and any known method can be used. Examples include an emulsion polymerization method in an aqueous medium; a method in which the rubber polymer (a) and the emulsifier are melt-kneaded by a known melt-kneading means such as a kneader, a Banbury mixer, a multi-screw extruder or the like, and then dispersed by applying mechanical shear force, followed by adding the resulting mixture to an aqueous medium; a method in which the rubber polymer (a) is dissolved together with an emulsifier in a hydrocarbon solvent such as pentane, hexane, heptane, benzene, toluene, xylene or the like, and the solution is added to an aqueous medium to emulsify, followed by thorough stirring and distilling off the hydrocarbon solvent, and the like.

In terms of ease of controlling the particle size, the emulsion polymerization method in an aqueous medium is preferred for diene-based rubbers, acrylic rubbers, silicone-based rubbers, and rubbers that take composite forms thereof. For silicone-based rubbers, olefin-based rubbers, and rubbers that take composite forms thereof, the method in which the rubber polymer (a) and the emulsifier are melt-kneaded by a known melt-kneading means such as a kneader, a Banbury mixer, a multi-screw extruder or the like, and then dispersed by applying mechanical shear force, followed by adding the resulting mixture to an aqueous medium is preferred.

During melt-kneading, from the viewpoint of kneading properties, a wax component such as maleic anhydride-modified polyethylene may be used together with the emulsifier.

The emulsifier that can be used when emulsifying the rubber polymer (a) may be any commonly used emulsifier. Examples of the emulsifier include well-known ones such as long-chain alkyl carboxylates, alkyl ester salts of sulfosuccinic acid, alkylbenzene sulfonates, and the like.

There are no particular limitations as to whether the rubbery polymer (a) is crosslinked or not. The rubbery polymer (a) is preferably crosslinked in order to provide excellent impact resistance and color development properties. The gel content of the rubbery polymer (a) is preferably 60 to 99% by mass, and more preferably 80 to 98% by mass.

The gel content of the rubbery polymer (a) indicates the degree of crosslinking of the rubbery polymer (a). Specifically, the gel content of the rubbery polymer (a) is determined by dissolving a weighed amount of the rubbery polymer (a) in an appropriate solvent for 40 hours, then separating the dissolved material through a 200-mesh wire gauze, drying the insoluble matter remaining on the wire gauze, weighing it, and calculating the ratio (% by mass) of the dried insoluble matter to the rubbery polymer (a) before dissolving it in the solvent.

Examples of solvents used to dissolve the rubbery polymer (a) include toluene for diene-based rubbers or olefin-based rubbers, which facilitates measurement, and acetone for acrylic rubbers, which also facilitates measurement.

There are no particular limitations on the method for crosslinking the rubbery polymer (a), and known methods can be used. For example, a method of adjusting the amount of an organic peroxide or chain transfer agent used during emulsion polymerization of the diene-based rubber; a method of copolymerizing diene-based rubber or acrylic rubber with a polyfunctional compound during polymerization; a method of adding an organic peroxide and, if necessary, a polyfunctional compound to diene-based rubber, silicon-based rubber, or olefin-based rubber and heating the mixture, and the like; are preferred because they make it easy to adjust the degree of crosslinking.

There are no particular limitations on the organic peroxide. Examples include peroxyester compounds, peroxyketal compounds, dialkyl peroxide compounds, and the like. One or more of these can be used.

From the viewpoints of easily adjusting the gel content of the rubbery polymer (a) to a range of 40 to 99% by mass and easily achieving impact resistance, it is preferable to use 0.01 to 5 parts by mass of the organic peroxide based on 100 parts by mass of the rubbery polymer (a).

Similarly, it is preferable to use the polyfunctional compound in an amount of 10 parts by mass or less based on 100 parts by mass of the rubbery polymer (a), from the viewpoints of easily adjusting the gel content of the rubbery polymer (a) to a range of 40 to 99% by mass and easily achieving impact resistance.

The graft copolymer (B) is obtained by graft polymerizing a monomer (b) with such rubbery polymer (a). The monomer (b) contains an aromatic vinyl-based monomer and a vinyl cyanide-based monomer, and may also contain other monomers.

Examples of the aromatic vinyl-based monomer include styrene, α-methylstyrene, o-, m-, or p-methylstyrene, vinylxylene, p-t-butylstyrene, ethylstyrene, and the like. One or more of these can be used. Among these, styrene and α-methylstyrene are preferred.

Examples of the vinyl cyanide-based monomer include acrylonitrile, methacrylonitrile, and the like. One or more of these can be used.

The other monomer is a monomer copolymerizable with the vinyl cyanide-based monomer and the aromatic vinyl-based monomer. Examples of the other monomer copolymerizable with the vinyl cyanide-based monomer and the aromatic vinyl-based monomer include methacrylic acid esters and acrylic acid esters, such as methyl methacrylate methyl acrylate, and the like, and maleimide compounds such as N-phenylmaleimide, N-cyclohexylmaleimide, and the like.

The content of the vinyl cyanide-based monomer and the aromatic vinyl-based monomer in 100% by mass of the monomer (b) is preferably 70 to 82% by mass of the aromatic vinyl-based monomer and 18 to 30% by mass of the vinyl cyanide-based monomer. When the content of the aromatic vinyl-based monomer and the vinyl cyanide-based monomer in the monomer (b) is within the above ranges, the molded appearance and impact resistance of the resulting resin composition will be further improved.

When the monomer (b) contains the above-mentioned other monomers, it is preferable for the purpose of the present invention that the content of the other monomers in 100% by mass of the monomer (b) is 30% by mass or less, particularly 20% by mass or less, and especially 10% by mass or less. In this case, it is preferable that the aromatic vinyl-based monomer and the vinyl cyanide-based monomer in the monomer (b) are contained in an amount of 70 to 82% by mass of the aromatic vinyl-based monomer and 18 to 30% by mass of the vinyl cyanide-based monomer, based on 100% by mass of the total of the aromatic vinyl-based monomer and the vinyl cyanide-based monomer.

The graft copolymer (B) is obtained by graft polymerizing the monomer (b) in the presence of the rubbery polymer (a). During the graft polymerization, the proportion of the rubbery polymer (a) is preferably 40 to 80% by mass, and the proportion of the monomer (b) is preferably 20 to 60% by mass (where the total of the rubbery polymer (a) and the monomer (b) is 100% by mass). Generally, when the proportion of the rubbery polymer (a) is within the above range, the productivity of the graft copolymer (B) is good, and the molded appearance and impact resistance of the resulting resin composition and molded articles are improved.

Since the resulting resin composition and molded articles thereof have good molded appearance and impact resistance, the graft ratio of the graft copolymer (B) is preferably 20 to 100%, and more preferably 30 to 60%.

The graft ratio (G) in this specification is calculated using the following formula.

$$G = 100 ( P - E ) / E$$

P: Mass of acetone-insoluble matter (mass after washing the graft copolymer (B) or resin composition with methanol, extracting it with acetone, separating it into acetone-soluble and acetone-insoluble matter using a centrifuge, and vacuum-drying the resulting acetone-insoluble matter) (g)
E: Mass of the rubbery polymer (a) used to produce the graft copolymer (B) (g)

The graft copolymer (B) is produced by known methods such as bulk polymerization, solution polymerization, bulk suspension polymerization, suspension polymerization, emulsion polymerization, or the like. Emulsion polymerization is preferred from the viewpoints of easy control of the particle size and ease of polymerization.

The content of the vinyl cyanide-based monomer in the acetone-soluble matter of the graft copolymer (B) of the present invention is preferably 18 to 30% by mass based on 100% by mass of the acetone-soluble matter.

The mass-average molecular weight (Mw) of the copolymer component in the acetone-soluble matter of the graft copolymer (B) is preferably in the range of 40,000 to 200,000, more preferably 50,000 to 160,000, and even more preferably 60,000 to 120,000. When the mass-average molecular weight of the acetone-soluble matter is within this range, the thermoplastic resin composition exhibits excellent impact resistance, heat resistance, and moist heat aging resistance.

The molecular weight distribution (Mw/Mn), which is the ratio of the mass-average molecular weight (Mw) to the number-average molecular weight (Mn) of the copolymer component in the acetone-soluble matter, is preferably in the range of 1.8 to 4.5, more preferably 2.0 to 3.0. When the molecular weight distribution is within this range, the thermoplastic resin composition more effectively exhibits excellent impact resistance, heat resistance, and moist heat aging resistance.

The mass-average molecular weight (Mw) and molecular weight distribution (Mw/Mn) of the copolymer component in the acetone-soluble matter are measured using the method described in the Examples section below.

The graft copolymer (B) may be used alone or in the form of a mixture of two or more different types of constituent components, compositions, physical properties, and the like.

The blending amount of the graft copolymer (B) in the resin composition of the present invention is 10 to 45 parts by mass, preferably 10 to 40 parts by mass, more preferably 10 to 35 parts by mass, and most preferably 10 to 30 parts by mass based on 100 parts by mass of the total of the components (A) to (D), because the resulting resin composition and molded articles thereof are excellent in the molded appearance, impact resistance, and heat resistance.

When the amount of the graft copolymer (B) is less than the above lower limit, the impact resistance tends to be inferior. When the amount of the graft copolymer (B) is more than the above upper limit, the molded appearance tends to be inferior.

### [Aromatic Vinyl-Vinyl Cyanide-based Copolymer (C)]

The aromatic vinyl-vinyl cyanide-based copolymer (C) of the present invention is obtained by copolymerizing a monomer (c) containing an aromatic vinyl-based monomer and a vinyl cyanide-based monomer. The monomer (c) may also contain other copolymerizable monomers.

Examples of the aromatic vinyl-based monomer constituting the aromatic vinyl-vinyl cyanide-based copolymer (C) include vinyltoluenes such as styrene, α-methylstyrene, p-methylstyrene, and the like; halogenated styrenes such as p-chlorostyrene, and the like; p-t-butylstyrene, dimethylstyrene, vinylnaphthalenes, and the like. These may be used alone or in combination of two or more. Among these, styrene and α-methylstyrene are preferred as the aromatic vinyl-based monomers.

Examples of the vinyl cyanide-based monomer constituting the aromatic vinyl-vinyl cyanide-based copolymer (C) include acrylonitrile, methacrylonitrile, and the like. These may be used alone or in combination of two or more. Among these, acrylonitrile is preferred as a vinyl cyanide-based monomer.

In addition to the vinyl cyanide-based monomers and the aromatic vinyl-based monomers, the monomer (c) may also contain one or more other monomers copolymerizable with them. Examples of the other copolymerizable monomers include methacrylic acid esters and acrylic acid esters, such as methyl methacrylate, methyl acrylate, and the like, and maleimide compounds, such as N-phenylmaleimide, N-cyclohexylmaleimide, and the like.

The content ratios of the aromatic vinyl-based monomer and the vinyl cyanide-based monomer in 100% by mass of the monomer (c) are preferably as follows: The monomer (c) contains preferably 60 to 85% by mass of the aromatic vinyl-based monomer and 15 to 40% by mass of the vinyl cyanide-based monomer; more preferably 65 to 80% by mass of the aromatic vinyl-based monomer and 20 to 35% by mass of the vinyl cyanide-based monomer; and even more preferably 68 to 778 by mass of the aromatic vinyl-based monomer and 23 to 32% by mass of the vinyl cyanide-based monomer (where the total of the aromatic vinyl-based monomer and the vinyl cyanide-based monomer is 100% by mass).

When the content ratios of the aromatic vinyl-based monomer and the vinyl cyanide-based monomer are within the above ranges, the thermoplastic resin composition exhibits excellent appearance and can exhibit excellent effects in impact resistance, moist heat aging resistance, and recyclability.

When the monomer (c) contains the above-mentioned one or more other monomers, it is preferable for achieving the objectives of the present invention that the content of one or more other monomers in 100% by mass of the monomer (c) is 20% by mass or less, particularly 10% by mass or less, and especially 5% by mass or less. In this case, the contents of the aromatic vinyl-based monomer and the vinyl cyanide-based monomer in the monomer (c) are preferably 60 to 85% by mass of the aromatic vinyl-based monomer and 15 to 40% by mass of the vinyl cyanide-based monomer, more preferably 65 to 80% by mass of the aromatic vinyl-based monomer and 20 to 35% by mass of the vinyl cyanide-based monomer, and even more preferably 68 to 77% by mass of the aromatic vinyl-based monomer and 23 to 32% by mass of the vinyl cyanide-based monomer, based on 100% by mass of the total of the aromatic vinyl-based monomer and the vinyl cyanide-based monomer in the monomer (c).

There are no particular limitations on the method for producing the aromatic vinyl-vinyl cyanide-based copolymer (C). The aromatic vinyl-vinyl cyanide-based copolymer (C) may be produced by known methods such as bulk polymerization, solution polymerization, bulk suspension polymerization, suspension polymerization, emulsion polymerization, and the like, in the presence of the monomer (c) and, optionally, a polymerization initiator, chain transfer agent, and suspension stabilizer. Among these methods, suspension polymerization is preferred because it produces fewer impurities such as oligomers, solvents, emulsifiers, and the like. The suspension polymerization method was also used in the Examples described below.

As the chain transfer agent, known compounds such as mercaptans such as n-octyl mercaptan, n-dodecyl mercaptan, t-dodecyl mercaptan, and the like, terpene compounds such as terpinolene, and the like, α-methylstyrene dimer, and the like can be used.

As the polymerization initiator, known compounds can also be used. Examples of the polymerization initiator include organic peroxides such as benzoyl peroxide, lauroyl peroxide, and the like, and azo-based initiators such as azobisisobutyronitrile, and the like.

As the suspension stabilizer during the suspension polymerization, known compounds can also be used. Examples of the suspension stabilizer include organic polymeric substances such as polyvinyl alcohol, polyacrylate salts, carboxymethyl cellulose, gelatin, tragacanth, and the like; inorganic colloidal substances such as barium sulfate, magnesium carbonate, calcium phosphate, and the like; and combinations of these with surfactants, and the like.

The mass-average molecular weight (Mw) of the aromatic vinyl-vinyl cyanide-based copolymer (C) is preferably in the range of 50,000 to 350,000, more preferably 100,000 to 300,000, and even more preferably 150,000 to 250,000. When the mass-average molecular weight of the aromatic vinyl-vinyl cyanide-based copolymer (C) is within this range, the excellent impact resistance, heat resistance, and moist heat aging resistance of the thermoplastic resin composition can be more effectively exhibited, and these properties are less susceptible to the effects of molding temperature and environmental conditions.

The molecular weight distribution (Mw/Mn), which is the ratio of the mass-average molecular weight (Mw) to the number-average molecular weight (Mn) of the aromatic vinyl-vinyl cyanide-based copolymer (C), is preferably in the range of 1.5 to 3.5, and more preferably in the range of 2.0 to 3.0. When the molecular weight distribution (Mw/Mn) of the aromatic vinyl-vinyl cyanide-based copolymer (C) is within this range, the excellent impact resistance, heat resistance, and moist heat aging resistance of the thermoplastic resin composition can be more effectively exhibited, and these properties are less susceptible to the effects of molding temperature and environmental conditions.

The mass-average molecular weight (Mw) and molecular weight distribution (Mw/Mn) of the aromatic vinyl-vinyl cyanide-based copolymer (C) are measured using the method described in the Examples section below.

The aromatic vinyl-vinyl cyanide-based copolymer (C) may be used alone or in the form of a mixture of two or more different types of constituent components, compositions, physical properties, and the like.

The blending amount of the aromatic vinyl-vinyl cyanide-based copolymer (C) in the resin composition of the present invention is 5 to 49 parts by mass, preferably 5 to 44 parts by mass, more preferably 5 to 39 parts by mass, and even more preferably 5 to 34 parts by mass, based on 100 parts by mass of the total of the components (A) to (D).

The aromatic vinyl-vinyl cyanide-based copolymer (C) is a component effective in improving the weather resistance, impact resistance, heat resistance, and moist heat aging resistance of the resin composition of the present invention. When the content of the aromatic vinyl-vinyl cyanide-based copolymer (C) is equal to or more than the above lower limit, the impact resistance, heat resistance, and moist heat aging resistance are excellent. When the content of the aromatic vinyl-vinyl cyanide-based copolymer (C) is equal to or less than the above upper limit, the impact resistance and fluidity are excellent.

### [Aromatic Polycarbonate Resin (D)]

Although the aromatic polycarbonate resin (D) is not an essential component of the resin composition of the present invention, its inclusion can further improve the impact resistance of the resin composition and the molded article thereof.

The aromatic polycarbonate resin (D) used in the present invention can be produced by reacting one or more bisphenols with phosgene or a carbonate diester.

The viscosity-average molecular weight (Mv) of the aromatic polycarbonate resin (D) is preferably in the range of 10,000 to 50,000, and particularly 15,000 to 40,000. When the viscosity-average molecular weight (Mv) of the aromatic polycarbonate resin (D) is below this range, the impact resistance tends to decrease. When the viscosity-average molecular weight (Mv) of the aromatic polycarbonate resin (D) exceeds this range, the fluidity tends to decrease and the moldability tends to deteriorate.

The viscosity-average molecular weight of the aromatic polycarbonate resin (D) can usually be calculated by inserting the specific viscosity (ηsp) measured at 20° C. and a concentration of 0.7 g/100 ml (methylene chloride) using methylene chloride as the solvent into the following formula:

$$Viscosity - average molecular weight = {( [ η ] \times 8130 )}^{1.205}$$

$$Here , [ η ] = [ {( η sp \times 1.12 + 1 )}^{1 / 2} - 1 ] / 0.56 C , and C represents the concentration .$$

The mass-average molecular weight (Mw) of the aromatic polycarbonate resin (D) is preferably in the range of 12,000 to 80,000, particularly 16,000 to 50,000. When the mass-average molecular weight (Mw) of the aromatic polycarbonate resin (D) is below this range, the impact resistance tends to decrease. When the mass-average molecular weight (Mw) of the aromatic polycarbonate resin (D) exceeds this range, the fluidity tends to decrease and the moldability tends to deteriorate.

The molecular weight distribution (Mw/Mn) of the aromatic polycarbonate resin (D) is preferably in the range of 1.8 to 2.8, particularly 1.9 to 2.3. When the molecular weight distribution (Mw/Mn) is below this range, more energy is required for production. When the molecular weight distribution (Mw/Mn) exceeds this range, the moist heat aging resistance tends to deteriorate.

Here, the mass-average molecular weight (Mw) and molecular weight distribution (Mw/Mn) of the aromatic polycarbonate resin (D) are measured by the method described in the Examples section below.

Specific examples of bisphenols, which are raw materials for the aromatic polycarbonate resin (D), include hydroquinone, 4,4-dihydroxyphenyl, bis-(4-hydroxyphenyl)-alkane, bis-(4-hydroxyphenyl)-cycloalkane, bis-(4-hydroxyphenyl)-sulfide, bis-(4-hydroxyphenyl)-ether, bis-(4-hydroxyphenyl)-ketone, bis-(4-hydroxyphenyl)-sulfone, and alkyl-, aryl-, and halogen-substituted derivatives thereof. These can be used alone or in combination of two or more.

The aromatic polycarbonate resin (D) may be used alone or in the form of a mixture of two or more different types of constituent components, compositions, physical properties, and the like.

The blending amount of the aromatic polycarbonate resin (D) in the resin composition of the present invention is 0 to 40 parts by mass, preferably 5 to 35 parts by mass, more preferably 10 to 30 parts by mass, and even more preferably 15 to 30 parts by mass based on 100 parts by mass of the total of the components (A) to (D).

When the blending amount of the aromatic polycarbonate resin (D) exceeds the above upper limit, the color development and weather resistance of the resulting resin composition and molded articles thereof tend to be inferior.

### [Resin Components]

The thermoplastic resin composition of the present invention exhibits excellent properties by blending the isosorbide-based polycarbonate resin (A), the graft copolymer (B), the aromatic vinyl-vinyl cyanide-based copolymer (C), and an aromatic polycarbonate resin (D) in specified ratios. The thermoplastic resin composition of the present invention preferably further contains the isosorbide-based polycarbonate resin (A) and the aromatic vinyl-vinyl cyanide-based copolymer (C) in the following blending amounts.

In particular, when the resin composition contains the isosorbide-based polycarbonate resin (A) in a high range of 36 to 50 parts by mass, even 40 to 50 parts by mass based on 100 parts by mass of the total of the components (A) to (D), the effect of the moist heat aging resistance of the resin composition can be maximized by blending the aromatic vinyl-vinyl cyanide-based copolymer (C) in an amount preferably 5 to 44 parts by mass, more preferably 5 to 30 parts by mass, even more preferably 6 to 25 parts by mass, and particularly preferably 8 to 20 parts by mass based on 100 parts by mass of the total of the components (A) to (D).

The isosorbide-based polycarbonate resin (A), the graft copolymer (B), the aromatic vinyl-vinyl cyanide-based copolymer (C), and the aromatic polycarbonate resin (D) constituting the resin composition of the present invention may be obtained from commercially recovered materials or recycled products and used as a raw material.

Furthermore, the resin composition of the present invention itself is recyclable and can be used as a recycled raw material. Therefore, it is possible to design thermoplastic resin compositions by blending virgin raw materials depending on the application.

### [Other Resins]

The resin composition of the present invention may contain one or more resins other than the above-mentioned isosorbide-based polycarbonate resin (A), graft copolymer (B), aromatic vinyl-vinyl cyanide-based copolymer (C), and aromatic polycarbonate resin (D).

Examples of the other resins include impact modifiers having a composition or rudder content that does not fall under the graft copolymer (B) of the present invention, polystyrene resin, polyacetal resin, nylon resin, methacrylic resin, polyvinyl chloride resin, polyphenylene ether resin, polyesters such as polylactic acid resin, and the like. Blends of two or more of these may also be used. Furthermore, the above resins may be modified with compatibilizers, functional groups or the like. The above resins may also be recycled resins recovered from the market.

When the resin composition of the present invention contains these other resins, the content of the other resins is preferably 20 parts by mass or less based of 100 parts by mass of the total resin components, i.e., the isosorbide-based polycarbonate resin (A), graft copolymer (B), aromatic vinyl-vinyl cyanide-based copolymer (C), aromatic polycarbonate resin (D), and other resins in order to reliably obtain the effects of the resin composition comprising the above-mentioned isosorbide-based polycarbonate resin (A), graft copolymer (B), aromatic vinyl-vinyl cyanide-based copolymer (C), and aromatic polycarbonate resin (D).

### [Additives]

The resin composition of the present invention can be blended with one or more other conventional additives, such as lubricants, pigments, dyes, fillers (carbon black, silica, titanium oxide, and the like), heat resistance agents, antioxidants, weather resistance agents, mold release agents, plasticizers, antistatic agents, flame retardants, flame retardant aids, and the like, during production (mixing) or molding, as long as the additives do not impair the physical properties of the resin composition or molded article.

### [Method for Producing Resin Composition]

The resin composition of the present invention can be produced by known methods using known equipment. One example of the known methods is a melt mixing method. Examples of the equipment used in this method include extruders, Banbury mixers, rollers, kneaders, or the like. The mixing may be carried out in a batch or continuous manner. There are no particular limitations on the order in which the components are mixed, as long as all components are uniformly mixed.

### [Molded Article]

The molded article of the present invention is manufactured by molding the resin composition of the present invention described above. Examples of the molding method include injection molding, injection compression molding, extrusion, blow molding, vacuum molding, pressure molding, calendar molding, inflation molding, and the like. Among these, injection molding and injection compression molding are preferred because they are suitable for mass production and can produce molded articles having high dimensional accuracy.

### [Uses]

The molded articles of the present invention obtained by molding the resin composition of the present invention have excellent weather resistance, moist heat aging resistance, impact resistance, and heat resistance. Furthermore, they are highly recyclable. Therefore, the molded articles of the present invention obtained by molding the resin composition of the present invention can be used for electrical and electronic parts, automobile parts, mechanical parts, housing parts for office equipment or home appliances, general merchandise, building materials, and the like. In particular, the molded articles of the present invention obtained by molding the resin composition of the present invention can be used as automobile parts for both interior and exterior applications, and are particularly useful as exterior parts due to their excellent weather resistance and moist heat aging resistance.

### EXAMPLES

The present invention will be explained in more detail below using Production Examples, Examples, and Comparative Examples. The present invention is not limited in any way to the following Examples, provided it does not deviate from the gist of the present invention.

In the following, “parts” means “parts by mass.”

In the following, the volume average particle diameter of the rubbery polymer (a) was measured using “Nanotrac 150” manufactured by Nikkiso Co., Ltd.

The gel content of the rubbery polymer (a) and the graft ratio of the graft copolymer were determined using the methods described above.

In the following Examples, the mass P of the acetone-insoluble matter in the formula for the graft ratio (G) described above is the mass (g) of after washing each of the graft copolymers (B1) and (B2) with methanol, extracting it with acetone, separating it into acetone-soluble and acetone-insoluble matter using a centrifuge, and vacuum-drying the resulting acetone-insoluble matter.

The mass-average molecular weight (Mw) and molecular weight distribution (Mw/Mn) of the copolymer components of the acetone-soluble matter of the graft copolymer (B), the aromatic vinyl-vinyl cyanide-based copolymer (C), and the aromatic polycarbonate resin (D) were measured using the following method.

### <Measurement of Mass-Average Molecular Weight (Mw) and Molecular Weight Distribution (Mw/Mn)>

The mass-average molecular weight (Mw) and molecular weight distribution (Mw/Mn) were measured using GPC (GPC: “HLC8220” manufactured by Tosoh Corporation; column: “TSK GEL Super HZM-H” manufactured by Tosoh Corporation), and tetrahydrofuran (THF: 40° C.) as the solvent. The mass-average molecular weight (Mw) and molecular weight distribution (Mw/Mn) were measured in terms of polystyrene.

The copolymer component of the acetone-soluble matter of the graft copolymer (B) was measured by a method in which the acetone-soluble matter obtained in the graft ratio measurement of the graft copolymer (B) was dissolved in methanol, and then the polymer components were precipitated in methanol, dried in a vacuum dryer for 24 hours, and used for GPC measurement.

The aromatic vinyl-vinyl cyanide-based copolymer (C) was measured by a method in which the component (C) was dissolved in acetone, and then the polymer components were precipitated in methanol, dried in a vacuum dryer for 24 hours, and used for GPC measurement.

The aromatic polycarbonate resin (D) was measured by a method in which the component was dissolved in tetrahydrofuran (THF), and the polymer components were precipitated in acetone, dried in a vacuum dryer for 24 hours, and used for GPC measurement.

### [Isosorbide-Based Polycarbonate Resin (A)]

Isosorbide-based polycarbonate resin (A1): “D7340R” manufactured by Mitsubishi Chemical Corporation (isosorbide/1,4-cyclohexanedimethanol=70/30 (mol %), MFR: 10 g/10 min (ISO1133 230° C./2.16 kg)), containing 0.02% by mass of “ADEKA STAB (registered trade mark) LA-29” manufactured by ADEKA Corporation as a benzotriazole-based compound and 0.03% by mass of ethylene glycol distearate “E-275” manufactured by NOF Corporation as a polyhydric alcohol fatty acid ester)

### [Graft Copolymer (B)]

### Production Example 1: Graft Copolymer (B1)

(Production of Emulsified Latex of Ethylene-Propylene Copolymer (a-1))

100 parts of ethylene-propylene copolymer (ethylene/propylene=78/22(%), Mooney viscosity (ML1+4, 100° C.): 20, melting point (Tm): 40° C., glass transition temperature (Tg): −50° C.), 10 parts of low-molecular-weight modified polyethylene (“Hiwax 2203A” manufactured by Mitsui Chemicals, Inc.), and 3.1 parts of potassium oleate were mixed. Next, the mixture was fed at a rate of 6 kg/hour from the hopper of a twin-screw extruder (“PCM-30” manufactured by Ikegai Steel Co., Ltd., L/D=40). While continuously feeding a 15% by mass aqueous solution of potassium hydroxide at a rate of 110 g/hour, the mixture was melt-kneaded at a heating temperature of 200° C. to extrude a molten material. The molten material was then continuously fed to a cooling single-screw extruder attached to the tip of the extruder and cooled to 90° C. The removed solid was poured into warm water at 80° C. and continuously dispersed to obtain an ethylene-propylene copolymer latex having a volume average particle size of 340 nm.

1.2 parts of t-butylcumyl peroxide and 1.0 part of divinylbenzene were added to 100 parts of the solids content of this latex, and the mixture was reacted at 135° C. for 5 hours to prepare a latex of ethylene-propylene copolymer (a-1).

The gel content of the ethylene-propylene copolymer (a-1) was 76% by mass.

The gel content was determined by coagulating the copolymer latex with dilute sulfuric acid, washing with water, drying to obtain dried matter, taking 1 g thereof, immersing it in 200 mL of toluene for 40 hours, then filtering through a 200-mesh wire screen to obtain a residue, drying the residue, and measuring its mass.

### (Production of Graft Copolymer (B1))

60 parts (in terms of solid contents) of an emulsion latex of ethylene-propylene copolymer (a-1) (EPR) in a reactor were charged with 0.16 parts of sodium pyrophosphate, 0.008 parts of ferrous sulfate heptahydrate, and 0.38 parts of fructose to obtain a mixture, and the internal temperature was maintained at 80° C. A monomer mixture consisting of 30.0 parts of styrene (ST) and 10.0 parts of acrylonitrile (AN), and 0.5 parts of cumene hydroperoxide were simultaneously added dropwise to the mixture over 140 minutes through separate feed ports to conduct polymerization. During this process, the internal temperature was maintained at a constant 80° C. After the addition was completed, the temperature was maintained at 80° C. for an additional 100 minutes, after which the mixture was cooled to complete the graft polymerization. The reaction product latex was coagulated with an aqueous sulfuric acid solution, washed with water, and dried to obtain a graft copolymer (B1).

The composition (mass ratio) of the graft copolymer (B1) was AN/EPR/ST=9.9/60.2/29.9, and the graft rate was 448. The mass-average molecular weight (Mw) of the acetone-soluble matter of the graft copolymer (B1) was 68,000, and the molecular weight distribution (Mw/Mn) was 2.8.

### Production Example 2: Graft Copolymer (B2)

A nitrogen-purged reactor was charged with 120 parts of pure water, 0.5 parts of glucose, 0.5 parts of sodium pyrophosphate, 0.005 parts of ferrous sulfate, and 60 parts (in terms of solid contents: 95% gel content) of polybutadiene latex (a-2) (BD) having a volume average particle diameter of 340 nm as the rubbery polymer (a), and a temperature in the reactor was increased to 65° C. while agitation was performed. The point in time when the internal temperature reached 65° C. was assumed to be the start of polymerization, and 29 parts of styrene (ST), 11 parts of acrylonitrile (AN), and 0.25 parts of a chain transfer agent consisting of t-dodecylmercaptan mixture were continuously added over 5 hours. Simultaneously, an aqueous solution composed of cumenehydroperoxide (0.2 parts) as a polymerization initiator and potassium oleate was continuously added over 7 hours so as to complete a reaction. The resulting latex was mixed with 1 part of 2,2′-methylenebis(4-methyl-6-t-butylphenol) relative to 100 parts of latex solid contents. Subsequently, the latex was coagulated with sulfuric acid, neutralized with sodium hydroxide, washed, filtered, and dried so as to obtain a powder-like graft copolymer (B2).

The composition (mass ratio) of the graft copolymer (B2) was AN/BD/ST=10.7/60.1/29.2, and the graft rate was 58%. The mass-average molecular weight (Mw) of the acetone-soluble matter of the graft copolymer (B2) was 85,000, and the molecular weight distribution (Mw/Mn) was 3.1.

### [Aromatic Vinyl-Vinyl Cyanide-based Copolymer (C)]

### Production Example 3: Production of Aromatic Vinyl-Vinyl Cyanide-Based Copolymer (C1)

120 parts of water, 0.002 parts of sodium alkylbenzenesulfonate, 0.5 parts of polyvinyl alcohol, 0.3 parts of azobisisobutyronitrile, 0.1 parts of t-dodecyl mercaptan, 0.3 parts of terpinolene, and a monomer mixture comprising 26 parts of acrylonitrile and 74 parts of styrene were fed in a nitrogen-purged reactor. While adding a portion of styrene at short intervals, the reaction mixture was heated from an initial temperature of 60° C. over 5 hours to reach 120° C. After further reacting at 120° C. for 4 hours, the polymer was recovered to obtain an aromatic vinyl-vinyl cyanide-based copolymer (C1) having an acrylonitrile/styrene ratio of 25.8/74.2 (by mass).

The mass-average molecular weight (Mw) of the resulting aromatic vinyl-vinyl cyanide-based copolymer (C1) was 196,000 and the molecular weight distribution (Mw/Mn) was 2.9.

### Production Example 4: Production of Aromatic Vinyl-Vinyl Cyanide-Based Copolymer (C2)

120 parts of water, 0.002 parts of sodium alkylbenzenesulfonate, 0.5 parts of polyvinyl alcohol, 0.3 parts of azobisisobutyronitrile, 0.4 parts of t-dodecyl mercaptan, and a monomer mixture comprising 27 parts of acrylonitrile and 73 parts of styrene were fed in a nitrogen-purged reactor. While adding a portion of styrene at short intervals, the reaction mixture was heated from an initial temperature of 60° C. over 5 hours to reach 120° C. After further reacting at 120° C. for 4 hours, the polymer was recovered to obtain an aromatic vinyl-vinyl cyanide-based copolymer (C2) having an acrylonitrile/styrene ratio of 26.8/73.2 (by mass).

The mass-average molecular weight (Mw) of the resulting aromatic vinyl-vinyl cyanide-based copolymer (C2) was 132,000 and the molecular weight distribution (Mw/Mn) was 2.0.

### Production Example 5: Production of Aromatic Vinyl-Vinyl Cyanide-Based Copolymer (C3)

An aromatic vinyl-vinyl cyanide-based copolymer (C3) having an acrylonitrile/styrene ratio of 25.5/74.5 (by mass) was obtained in the same manner as in Production Example 4, except 0.62 parts of t-dodecyl mercaptan and a monomer mixture of 26 parts of acrylonitrile and 74 parts of styrene were used.

The mass-average molecular weight (Mw) of the resulting aromatic vinyl-vinyl cyanide-based copolymer (C3) was 92,000 and the molecular weight distribution (Mw/Mn) was 2.1.

### [Aromatic Polycarbonate Resin (D)]

The following commercially available aromatic polycarbonate resins were used.
Aromatic polycarbonate resin (D1): “200-20” manufactured by Sumika Polycarbonate Limited (Mw: 36,000, Mw/Mn: 1.9)
Aromatic polycarbonate resin (D2): “R-30 (recycled product)” manufactured by Kotec Ltd. (Mw: 39,000, Mw/Mn: 2.1)

### Examples 1 to 13, Comparative Examples 1 to 3

The components produced above were mixed according to the proportion shown in Table 1, and 0.2 parts of Adekastab “2112 (trade name)” manufactured by ADEKA Corporation (tris(2,4-di-t-butylphenyl)phosphite) was further added as a phosphite-based antioxidant. The mixture was melt-kneaded at 260° C. using a 28 mm twin-screw extruder (“TEX-28V” manufactured by the Japan Steel Works, Ltd.) to obtain a pelletized resin composition.

The resulting resin compositions were evaluated for weather resistance, moist heat aging resistance, molded appearance, impact resistance, and heat resistance by the following methods.

The evaluation results are shown in Table 1.

In Table 1, the unit for each component in the thermoplastic resin composition is “parts.”

### <Weather Resistance>

100 parts of the resulting resin composition was mixed with 0.8 parts of carbon black for coloring, and a 100×100 mm (having a thickness of 2 mm) black-colored plate (test piece) was injection molded.

This black-colored plate (test piece) was treated for 400 hours using a Sunshine Weather Meter (manufactured by Suga Test Instruments Co., Ltd.) at a black panel temperature of 63° C. and a 60-minute cycle (including 12 minutes of rainfall). The degree of discoloration (ΔE) before and after treatment was measured and evaluated using a color difference meter. The smaller this value, the better the weather resistance.

### <Moist Heat Aging Resistance>

### (MFR Increase Rate)

Pellets of the resulting resin composition were placed in a constant temperature and humidity chamber controlled at 80° C. and 95% RH for 500 hours (moist heat aging treatment), and then thoroughly dried at 80° C. for 24 hours to obtain moist heat aging-treated pellets.

The fluidity (MFR) of the moist heat aging-treated pellets was measured, and the MFR increase rate was calculated using the MFR measurement value of the pellets before the moist heat aging treatment (initial value) using the following formula.

$$MFR Increase Rate ( \% ) = [ MFR after moist heat aging treatment - initial MFR ] / initial MFR \times 100$$

The MFR immediately after production (0 hours of moist heat aging treatment) was used as the initial value.

The lower the MFR increase rate, the better the moist heat aging resistance.

### (IMP Retention Rate)

The pellets after the above-mentioned moist heat aging treatment were injection molded and subjected to the same impact resistance measurement described below. Using the measured value of the pellets before moist heat aging treatment (initial), the impact strength (IMP) retention rate was calculated using the following formula.

$$IMP Retention Rate ( \% ) = IMP after moist heat aging treatment / Initial IMP \times 100$$

The IMP immediately after production (0 hours of moist heat aging treatment) was used as the initial value.

The higher the IMP retention rate, the better the moist heat aging resistance.

### <Molded Appearance>

For injection molded articles of the obtained resin compositions, the reflectance (%) of the surface of the molded article was measured at an incident angle of 60° and a reflection angle of 60° in accordance with JIS K7105 using “Digital Variable Gloss Meter UGV-5D” manufactured by Suga Test Instruments Co., Ltd. The higher the reflectance, the better the surface appearance.

### <Impact Resistance>

For injection molded articles of the obtained resin compositions, 4 mm V-notched Charpy impact strength (KJ/m²) was measured at 23° C. in accordance with ISO test method 179. This value was taken as the initial IMP for the IMP retention rate.

### <Heat Resistance>

The heat deflection temperature (° C.) of the injection molded article of the obtained resin composition was measured in accordance with ISO Test Method 75 under a load of 1.83 MPa, with a specimen thickness of 4 mm, using the flatwise method.

TABLE 1

| | | | Exam- | Exam- | Exam- | Exam- | Exam- | Exam- | Exam- | Exam- | Exam- |
|---|---|---|---|---|---|---|---|---|---|---|---|
| | | | ple 1 | ple 2 | ple 3 | ple 4 | ple 5 | ple 6 | ple 7 | ple 8 | ple 9 |
| Blend | Isosorbide-based | (A1) | 50 | 30 | 50 | 50 | 50 | 50 | 50 | 50 | 40 |
| composition of | Polycarbonate Resin (A) | | | | | | | | | | |
| Thermoplastic | Graft Copolymer (B) | (B1) | 10 | 16 | 16 | 0 | 10 | 30 | 20 | 10 | 10 |
| Resin | | (B2) | 10 | 16 | 0 | 16 | 0 | 0 | 20 | 10 | 10 |
| Composition | Aromatic Vinyl-Vinyl | (C1) | 0 | 0 | 0 | 0 | 0 | 0 | 10 | 0 | 0 |
| | Cyanide-based Copolymer (C) | (C2) | 0 | 0 | 0 | 0 | 0 | 0 | 0 | 0 | 0 |
| | | (C3) | 30 | 38 | 34 | 34 | 40 | 20 | 0 | 10 | 10 |
| | Aromatic Polycarbonate | (D1) | 0 | 0 | 0 | 0 | 0 | 0 | 0 | 20 | 30 |
| | Resin (D) | (D2) | 0 | 0 | 0 | 0 | 0 | 0 | 0 | 0 | 0 |

| Evaluation | Weather Resistance ΔE (400 hr) | | 0.7 | 0.7 | 0.8 | 0.6 | 0.8 | 0.8 | 1.2 | 0.8 | 0.8 |
|---|---|---|---|---|---|---|---|---|---|---|---|
| Results | Moist Heat Aging | MFR Increase | 4 | 3 | 4 | 4 | 4 | 4 | 4 | 17 | 19 |
| | Resistance | Rate (%) | | | | | | | | | |
| | (500 hr) | IMP Retention | 96 | 97 | 94 | 96 | 96 | 96 | 96 | 82 | 80 |
| | | Rate (%) | | | | | | | | | |

| | | | | | | | | | | |
|---|---|---|---|---|---|---|---|---|---|---|
| Molded Appearance (Reflectance) | % | 97 | 100 | 100 | 100 | 100 | 100 | 95 | 92 | 94 |
| Impact Resistance | KJ/m² | 9 | 5 | 12 | 6 | 5 | 35 | 25 | 20 | 24 |
| Heat Resistance | ° C. | 90 | 88 | 89 | 89 | 90 | 83 | 83 | 97 | 98 |

| | | | Exam- | Exam- | Exam- | Exam- | Comparative | Comparative | Comparative |
|---|---|---|---|---|---|---|---|---|---|
| | | | ple 10 | ple 11 | ple 12 | ple 13 | Example 1 | Example 2 | Example 3 |
| Blend | Isosorbide-based | (A1) | 35 | 50 | 50 | 50 | 0 | 40 | 40 |
| composition of | Polycarbonate Resin (A) | | | | | | | | |
| Thermoplastic | Graft Copolymer (B) | (B1) | 10 | 10 | 10 | 10 | 15 | 15 | 15 |
| Resin | | (B2) | 10 | 10 | 10 | 10 | 15 | 15 | 15 |
| Composition | Aromatic Vinyl-Vinyl | (C1) | 10 | 0 | 10 | 10 | 40 | 0 | 0 |
| | Cyanide-based Copolymer (C) | (C2) | 0 | 10 | 0 | 0 | 0 | 0 | 0 |
| | | (C3) | 0 | 0 | 0 | 0 | 0 | 0 | 0 |
| | Aromatic Polycarbonate | (D1) | 35 | 20 | 20 | 0 | 30 | 30 | 0 |
| | Resin (D) | (D2) | 0 | 0 | 0 | 20 | 0 | 0 | 30 |

| Evaluation | Weather Resistance ΔE (400 hr) | | 1.2 | 0.8 | 0.8 | 1.0 | 1.4 | 1.4 | 1.9 |
|---|---|---|---|---|---|---|---|---|---|
| Results | Moist Heat Aging | MFR Increase | 23 | 15 | 10 | 12 | 20 | 20 | 30 |
| | Resistance | Rate (%) | | | | | | | |
| | (500 hr) | IMP Retention | 76 | 85 | 92 | 90 | 79 | 79 | 58 |
| | | Rate (%) | | | | | | | |

| | | | | | | | | |
|---|---|---|---|---|---|---|---|---|
| Molded Appearance (Reflectance) | % | 94 | 92 | 92 | 91 | 100 | 100 | 97 |
| Impact Resistance | KJ/m² | 35 | 27 | 32 | 32 | 25 | 25 | 23 |
| Heat Resistance | ° C. | 100 | 97 | 97 | 97 | 89 | 89 | 89 |

### DISCUSSION

As shown in Examples 1 to 13 in Table 1, the thermoplastic resin compositions of the present invention and molded articles thereof were excellent in weather resistance and molded appearance, as well as in impact resistance and moist heat aging resistance.

Even in Example 13, using the recycled aromatic polycarbonate resin (D2), excellent moist heat aging resistance was observed.

Thus, the thermoplastic resin compositions of the present invention exhibit excellent moist heat aging resistance and maintain performance well upon reuse (recyclability) of molded articles.

On the other hand, the thermoplastic resin compositions and molded articles of Comparative Examples 1 to 3 were insufficient in at least one of weather resistance and moist heat aging resistance.

Comparative Example 1, which did not contain the isosorbide-based polycarbonate resin (A), lacked sustainability.

Comparative Examples 2 and 3, which did not contain the aromatic vinyl-vinyl cyanide-based copolymer (C), exhibited poor moist heat aging resistance. In particular, it is clear that Comparative Example 3, using the recycled aromatic polycarbonate resin (D2), tends to exhibit increased fluidity, making it difficult to achieve moist heat aging resistance in impact strength.

Although the present invention has been described in detail by way of the specific modes, it is apparent for those skilled in the art that various changes can be made without departing from the spirit and scope of the present invention.

The present application is based on Japanese Patent Application No. 2024-108366 filed on Jul. 4, 2024, the entire contents of which are incorporated herein by reference.

1. A thermoplastic resin composition comprising:
1 to 50 parts by mass of a polycarbonate resin (A) containing an isosorbide structure, the polycarbonate resin (A) containing 65 to 75% by mol of structural units derived from dihydroxy compounds represented by the following formula (1) among all structural units derived from dihydroxy compounds constituting the polycarbonate resin (A), and further containing 0.01 to 0.1% by mass of a benzotriazole-based compound;
10 to 45 parts by mass of a graft copolymer (B) obtained by graft polymerizing a rubbery polymer (a) with a monomer (b) containing an aromatic vinyl-based monomer and a vinyl cyanide-based monomer;
5 to 49 parts by mass of an aromatic vinyl-vinyl cyanide-based copolymer (C) obtained by copolymerizing a monomer (c) containing an aromatic vinyl-based monomer and a vinyl cyanide-based monomer; and
0 to 40 parts by mass of an aromatic polycarbonate resin (D),
wherein a total of the polycarbonate resin (A), the graft copolymer (B), the aromatic vinyl-cyanide vinyl-based copolymer (C), and the aromatic polycarbonate resin (D) is 100 parts by mass.

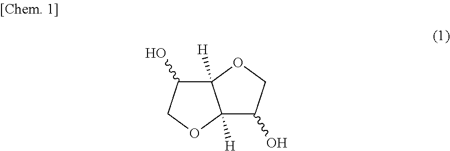

2. The thermoplastic resin composition according to claim 1, wherein the aromatic vinyl-vinyl cyanide-based copolymer (C) has a mass-average molecular weight (Mw) of 50,000 to 350,000 and a ratio of the mass-average molecular weight (Mw) to a number-average molecular weight (Mn) (Mw/Mn) of 1.5 to 3.5.

3. The thermoplastic resin composition according to claim 1, wherein the polycarbonate resin (A) contains structural units derived from the dihydroxy compound represented by the formula (1) and structural units derived from cyclohexanedimethanol, and the proportion of the structural units derived from cyclohexanedimethanol among all structural units derived from dihydroxy compounds contained in the polycarbonate resin (A) is 35% by mol or less.

4. The thermoplastic resin composition according to claim 1, wherein the polycarbonate resin (A) contains 0.1 to 0.5% by mass of a polyhydric alcohol fatty acid ester.

5. A molded article obtained by molding the thermoplastic resin composition according to claim 1.
